(19) United States
(12) Patent Application Publication
(10) Pub. No.: US 2016/0326656 A1
(43) Pub. Date: Nov. 10, 2016

(54) COLOR-TREATED BASE MATERIAL AND BASE MATERIAL COLOR TREATMENT METHOD THEREFOR

(71) Applicant: POSCO, Pohang-si, Gyeongsangbuk-do (KR)

(72) Inventors: Hyunju Jeong, Hwaseong-si, Gyeonggi-do (KR); Yun Ha Yoo, Yeonsu-gu, Incheon (KR); Jeong-Hee Lee, Yeonsu-gu, Incheon (KR); Ok-Hee Lim, Yeonsu-gu, Incheon (KR); Jaedong Cho, Yeonsu-gu, Incheon (KR)

(21) Appl. No.: 15/108,552

(22) PCT Filed: Dec. 26, 2014
(86) PCT No.: PCT/KR2014/012920

§ 371 Date: Jun. 27, 2016

(30) Foreign Application Priority Data
Dec. 26, 2013 (KR) 10-2013-0164044
Dec. 26, 2013 (KR) 10-2013-0164045
Dec. 26, 2013 (KR) 10-2013-0164046
Dec. 26, 2013 (KR) 10-2013-0164047
Dec. 26, 2014 (KR) 10-2014-0190347
Dec. 26, 2014 (KR) 10-2014-0190373

(51) Int. Cl. C23C 22/64; C09D 5/08; C01F 5/14; C23C 22/73

(52) U.S. Cl. CPC C23C 22/64; C23C 22/73; C09D 5/084; C01F 5/14

(57) ABSTRACT

The present invention relates to a color-treated base material and a base material color treatment method therefor. The base material is capable of improving the homogeneity and corrosion resistance of the surface of the base material and realizing a uniform color in a short period of time. Accordingly, the color-treated base material can be usefully used in the fields of building exterior materials, automobile interiors, and particularly electrical and electronic component materials, such as mobile phone case components, in which a magnesium material is used.

### TECHNICAL FIELD

The present invention relates to a color-treated substrate including magnesium and a substrate color treatment method therefor.

### BACKGROUND ART

Magnesium is a metal which belongs to lightweight metals among practical metals, has excellent wear resistance, and is very resistant to sunlight and eco-friendly, but has a difficulty in realizing a metal texture and various colors. Further, since it is a metal having the lowest electrochemical performance and is highly active, when a color treatment is not performed thereon, it may be quickly corroded in air or in a solution, and thus has a difficulty in industrial application.

Recently, the magnesium industry has been receiving attention due to the weight reduction trend in overall industry. As exterior materials with a metal texture has become trendy in the field of electrical and electronic component materials such as mobile phone case components, research to resolve the above-described problem of magnesium is being actively carried out.

As a result, Korean Patent Laid-open Publication No. 2011-0016750 disclosed a PVD-sol gel method of performing sol-gel coating after dry coating a surface of a substrate formed of a magnesium alloy with a metal-containing material in order to realize a metal texture and ensure corrosion resistance, and Korean Patent Laid-open Publication No. 2011-0134769 disclosed an anodic oxidation method of imparting gloss to a surface of a substrate including magnesium using chemical polishing and coloring a surface by anodic oxidation of the substrate in an alkaline electrolyte including a pigment dissolved therein.

However, the PVD-sol gel method has a problem in that a texture realized on the surface of the substrate is not the intrinsic texture of magnesium although a metal texture may be realized on the surface of the substrate, and the realization of a variety of colors is difficult. Furthermore, when a color treatment is performed using the anodic oxidation method, there is a problem in that an opaque oxide film is formed on the surface of the substrate, and the realization of the intrinsic texture of metals is not easy.

Accordingly, there is an urgent need for a technique to improve corrosion resistance by chemically, electrochemically or physically treating the surface of the substrate and to realize a desired color on the surface for commercialization of a substrate including magnesium.

### DISCLOSURE

### Technical Problem

In order to solve the problem, an objective of the present invention is to provide a color-treated substrate including magnesium.

Another objective of the present invention is to provide a method of color-treating the substrate.

### Technical Solution

In order to achieve the objectives, an embodiment of the present invention provides a color-treated substrate, including:

a matrix containing magnesium; and

a film formed on the matrix and containing a compound represented by the following Chemical Formula 1,

wherein, at any three points included in an arbitrary region with a width of 1 cm and a length of 1 cm which is present on the film, an average color coordinate deviation (ΔL*, Δa*, Δb*) of each point satisfies one or more conditions of ΔL*<0.6, Δa*<0.6 and Δb*<0.5:

M(OH)ₘ [Chemical Formula 1]

where M includes one or more selected from the group consisting of Na, K, Mg, Ca and Ba, and m is 1 or 2.

Further, another embodiment of the present invention provides a method of color-treating a substrate, including a step of immersing a matrix containing magnesium in a hydroxide solution.

### Advantageous Effects

The color-treated substrate according to the present invention includes a film containing a compound represented by Chemical Formula 1 formed on a surface of a matrix containing magnesium, and thus can improve the homogeneity and corrosion resistance of the surface of the substrate, and realize a uniform color in a short period of time. Accordingly, the color-treated substrate can be usefully used in the fields of building exterior materials, automobile interiors, and particularly electrical and electronic component materials, such as mobile phone case components, in which a magnesium material is used.

### DESCRIPTION OF DRAWINGS

FIG. 1 is a view illustrating a CIE color space.

FIG. 2 is a cross sectional view illustrating a color-treated substrate including a film with a patterned structure.

FIG. 3 is a cross sectional view illustrating a color-treated substrate including a film with a patterned structure which is formed by further performing a step of immersing in a hydroxide solution before patterning a surface of a matrix containing magnesium.

FIG. 4 shows images illustrating a thickness of a film according to immersion time, which is measured using a transmission electron microscope in an embodiment: where A shows a substrate in accordance with the immersion time of 10 minutes; B shows a substrate in accordance with the immersion time of 170 minutes; and C shows a substrate in accordance with the immersion time of 240 minutes.

FIG. 5 shows images of a surface of a substrate according to whether or not a color treatment is performed when evaluating corrosion resistance in an embodiment: where A shows a color-treated substrate; and B shows a non-color-treated substrate.

FIG. 6 is a graph illustrating potentiodynamic polarization curves of a substrate according to immersion time and whether or not a color treatment is performed.

### BEST MODE FOR CARRYING OUT THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Further, in the drawings of the present invention, the size and relative sizes of layers, regions and/or other elements may be exaggerated or reduced for clarity.

The embodiments of the present invention will be described with reference to the drawings. Throughout the specification, like reference numerals designate like elements and a repetitive description thereof will be omitted.

“Color coordinates”, as used herein, refer to coordinates in a CIE color space, including color values defined by the Commission International de l'Eclairage (CIE), and any position in the CIE color space may be expressed as three coordinate values of L*, a* and b*.

Here, an L* value represents brightness. L*=0 represents a black color, and L*=100 represents a white color. Moreover, an a* value represents whether a color at a corresponding color coordinate leans toward a pure magenta color or a pure green color, and a b* value represents whether a color at a corresponding color coordinate leans toward a pure yellow color or a pure blue color.

Specifically, the a* value ranges from −a to +a, the maximum a* value (a* max) represents a pure magenta color, and the minimum a* value (a* min) represents a pure green color. For example, when an a* value is negative, a color leans toward a pure green color, and when an a* value is positive, a color leans toward a pure magenta color. This indicates that, when a*=80 is compared with a*=50, a*=80 represents a color which is closer to a pure magenta color than a*=50. Furthermore, the b* value ranges from −b to +b. The maximum b* value (b* max) represents a pure yellow color, and the minimum b* value (b* min) represents a pure blue color. For example, when a b* value is negative, a color leans toward a pure blue color, and when a b* value is positive, a color leans toward a pure yellow color. This indicates that, when b*=50 is compared with b*=20, b*=80 shows a color which is closer to a pure yellow color than b*=50.

Further, a “color deviation” or a “color coordinate deviation”, as used herein, refers to a distance between two colors in the CIE color space. That is, a longer distance denotes a larger difference in color, and a shorter distance denotes a smaller difference in color, and this may be expressed by ΔE* represented by the following Expression 5:

ΔE*=\sqrt{(ΔL*)²+(Δa*)²+(Δb*)²} [Expression 5]

Moreover, an “intended pattern”, as used herein, refers to a pattern which is intentionally and/or deliberately introduced to a surface of a substrate according to the use of the substrate. Here, the pattern may include both a regular shape and an irregular shape.

Furthermore, a “wavelength conversion layer”, as used herein, refers to a layer for controlling a wavelength of incident light by adjusting reflection, refraction, scattering, diffraction or the like of light, which may serve to minimize additional refraction and scattering, in a top coat, of light refracted and scattered in a film, and maintain a color developed by the film by inducing light reflection.

Lastly, a unit “T”, as used herein, represents a thickness of a substrate including magnesium, and is the same as a unit “mm”.

The present invention provides a color-treated substrate including magnesium and a substrate color treatment method therefor.

A PVD-sol gel method, an anodic oxidation method or the like, which is a method of coating a surface of a material with a metal-containing material, a pigment or the like, has been conventionally known as a method for realizing a color on the material including magnesium. However, these methods may cause a reduction in durability of the substrate. Further, it is difficult to realize a uniform color on the surface of the material, and there is a problem of unmet reliability because a coated film layer is easily detached. Particularly, the intrinsic texture of metals is not realized in these methods, and thus, they are difficult to be applied in the fields of building exterior materials, automobile interiors, and particularly electrical and electronic component materials, such as mobile phone case components.

In order to address these issues, the present invention suggests a color-treated substrate including magnesium and a substrate color treatment method therefor according to the present invention.

The color-treated substrate according to the present invention may realize a uniform color in a short period of time by uniformly forming a layer on a surface of a matrix containing magnesium, and may realize various colors according to the thickness of the formed film. Further, there is an advantage in that the homogeneity and corrosion resistance of the surface of the substrate may be enhanced.

Hereinafter, the present invention will be described in further detail.

An embodiment of the present invention provides a color-treated substrate, including:

a matrix containing magnesium; and

a film formed on the matrix and containing a compound represented by the following Chemical Formula 1,

wherein, at any three points included in an arbitrary region with a width of 1 cm and a length of 1 cm which is present on the film, an average color coordinate deviation (ΔL*, Δa*, Δb*) of each point satisfies one or more conditions of ΔL*<0.6, Δa*<0.6 and Δb*<0.5:

M(OH)ₘ [Chemical Formula 1]

where M includes one or more selected from the group consisting of Na, K, Mg, Ca and Ba, and m is 1 or 2.

Specifically, the color-treated substrate may satisfy two or more of the conditions, and more specifically, may satisfy all the conditions.

In an embodiment, the color coordinates in a CIE color space of any three points which are present on the color-treated substrate according to the present invention were measured. The results of color coordinate deviations were respectively ΔL*<0.06, 0.23≦Δa*<0.31 and 0.01≦Δb*<0.21, all of which satisfy the conditions. Further, the ΔE* derived from the measured values was determined as 0.237≦ΔE*<0.375, which indicates a significantly small value of color coordinate deviation. This shows that the color-treated magnesium according to the present invention has a uniform color (refer to Experimental Example 1).

A color is realized on the color-treated substrate using a principle of scattering and refraction of light incident to the surface. When the scattering and refraction indices of the incident light is controlled by adjusting an average thickness of the film uniformly formed on the surface of the substrate, a desired color may be uniformly realized on the surface of the substrate.

Here, the matrix may be the same as a substrate before being subject to a color treatment. Any material may be used as the matrix as long as the material includes magnesium and is usable as a frame in the fields of electrical and electronic component materials, and the type or form of the matrix is not particularly limited. As an example, a magnesium substrate formed of magnesium; a stainless steel or titanium (Ti) substrate of which a surface has magnesium dispersed therein or the like may be used.

Further, an average thickness of the film may be specifically in the range of 50 nm to 2 μm, and more specifically in the range of 100 nm to 1 μm, but is not particularly limited thereto.

Moreover, the film may have a patterned structure which realizes an intended pattern on the matrix containing magnesium, and the pattern may be realized by an average thickness deviation of the film.

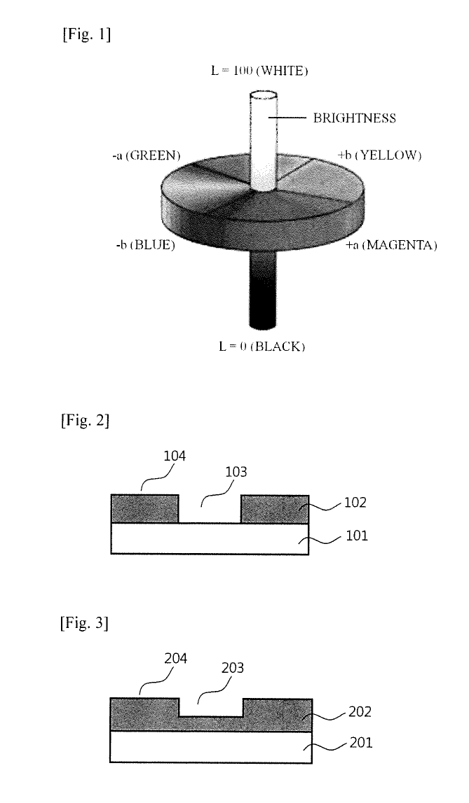

Referring to FIGS. 2 and 3, when films 102 and 202 include patterned regions 103 and 203 and non-patterned regions 104 and 204, and the patterned regions 103 and 203 may have a constant average thickness deviation with the non-patterned regions 104 and 204 by forming no layer or a thin layer on the matrices 101 and 201.

Here, the pattern may be realized by a difference in scattering and refraction indices of the incident light in accordance with the average thickness deviation of the films 102 and 202.

As an example, the average thickness deviation of the film may satisfy the condition of the following Expression 1.

5 nm≦|T₁−T₂|<2.0 μm [Expression 1]

where T₁ represents a film average thickness of a patterned region, and T₂ represents a film average thickness of a non-patterned region.

Specifically, the average thickness deviation of the film may be 5 nm or more and less than 2.0 μm, and more specifically, in the range of 5 nm to 100 nm; 50 nm to 0.5 μm; or 0.5 μm or more and less than 2.0 μm. In the present invention, a large difference in colors of the patterned region and non-patterned region is induced within the above-described range of the average thickness deviation so as to effectively realize a pattern.

Further, the color-treated substrate according to the present invention exhibits improved corrosion resistance by including the film on the matrix. Specifically, the color-treated substrate may satisfy the following Expression 2 when evaluating corrosion resistance:

Corrosion rate (Corr. Rate)≦0.01 [Expression 2]

where the corrosion rate (Corr. Rate) represents a degree of corrosion of a color-treated substrate measured in 0.5 wt % salt water at room temperature by a potentiodynamic polarization test, and has units of mm/year. Here, room temperature may be 25±2° C.

In an embodiment, a potentiodynamic polarization test in 0.5 wt % salt water was performed on a color-treated substrate and a non-color-treated substrate at room temperature to evaluate corrosion resistance of the substrates. As a result, it was confirmed that the corrosion rate (Corr. Rate) of the color-treated substrate was 0.0004 to 0.0013 mm/year while the corrosion rate of the non-color-treated substrate was 0.4322 mm/year. As can be seen from the results, the color-treated substrate according to the present invention has superior corrosion resistance in comparison with the non-color-treated substrate by forming a film on the surface (refer to Experimental Examples 3 and 4).

Here, a material of the film is not particularly limited as long as the film may scatter and refract the light incident to the surface. Specifically, the material of the film may be one or more of sodium hydroxide (NaOH), potassium hydroxide (KOH), magnesium hydroxide (Mg(OH)₂), calcium hydroxide (Ca(OH)₂) and barium hydroxide (Ba(OH)₂), and more specifically, may be magnesium hydroxide (Mg(OH)₂).

In an embodiment, X-ray diffraction analysis was performed on the film included in the color-treated substrate. As a result, the film was determined to have 2θ diffraction peak values of 18.5±1.0°, 38.0±1.0°, 50.5±1.0°, 58.5±1.0°, 62.0±1.0° and 68.5±1.0°. This indicates that the film formed on the surface of the substrate is formed of magnesium hydroxide (Mg(OH)₂) having a brucite crystalline structure. As can be seen from the results, the color-treated substrate according to the present invention includes magnesium hydroxide (Mg(OH)₂) (refer to Experimental Example 2).

Further, the color-treated substrate according to the present invention may further include a wavelength conversion layer and a top coat formed on the film.

Here, the type or form of the wavelength conversion layer is not particularly limited as long as the wavelength conversion layer may minimize additional refraction and scattering, in the top coat of light, refracted and/or scattered in the film, and maintain a color developed by the film by inducing light reflection. Specifically, the wavelength conversion layer may include one or more selected from the group consisting of metals including aluminum (Al), chromium (Cr), titanium (Ti), gold (Au), molybdenum (Mo), silver (Ag), manganese (Mn), zirconium (Zr), palladium (Pd), platinum (Pt), cobalt (Co), cadmium (Cd) or copper (Cu) and ions thereof, and specifically, may include chromium (Cr). Further, the metals may be in the form of metal particles, and may include various types such as a metal nitride, a metal oxide, a metal carbide or the like by reacting with a nitrogen gas, an ethane gas, an oxygen gas and the like in the process of forming the wavelength conversion layer. Moreover, the wavelength conversion layer may be a continuous layer in which the metals are densely stacked on the film and fully cover the surface of the film, or a discontinuous layer in which the metals are dispersed on the film, but is not limited thereto.

The top coat may be further included in order to improve scratch resistance and durability of the surface of the substrate including magnesium. Here, a clear coating agent for forming the top coat is not particularly limited as long as it is a clear coating agent which is applicable to metal coatings. More specifically, a matte clear coating agent or a glossy/matte clear coating agent which is applicable to metal coatings or the like may be exemplified.

When the color-treated substrate including the top coat was sprayed with 5 wt % salt water at 35° C. and the adhesiveness thereof was evaluated after 72 hours, the top coat may have a peel rate of 5% or less.

In an embodiment, the color-treated substrate having a matte or glossy/matte top coat formed thereon was sprayed with 5 wt % salt water at 35° C. and was tested by a cross-cut tape test method after 72 hours. As a result, it was determined that the area of the detached top coat was 5% or less with respect to the total area of the sample. As can be seen from the results, the substrate having the top coat formed thereon according to the present invention has excellent adhesiveness between the color-treated substrate and the top coat (refer to Experimental Example 5).

Furthermore, another embodiment of the present invention provides a method of color-treating a substrate, which includes a step of immersing a matrix containing magnesium in a hydroxide solution.

The method of color-treating the substrate according to the present invention may realize a color by uniformly forming a film on a surface of the substrate by immersing a matrix containing magnesium in a hydroxide solution.

Here, any solution including a hydroxyl group (—OH group) may be used as the hydroxide solution, without particular limitation. Specifically, a solution having one or more selected from the group consisting of NaOH, KOH, Mg(OH)₂, Ca(OH)₂ and Ba(OH)₂ dissolved therein may be used.

In an embodiment, the coloring speed, the coloring power and the color uniformity of the matrix containing magnesium were evaluated. As a result, when a solution in which NaOH had been dissolved was used as a hydroxide solution, it was confirmed that the coloring speed thereof is four times faster as compared to that of the case in which distilled water was used. Further, it was determined that the coloring power of the color developed on the surface is excellent, and a uniform color is realized. As can be seen from the results, when a solution in which a metal hydroxide such as NaOH or the like is dissolved is used as a hydroxide solution, the film is uniformly formed on the surface of the matrix in a short time, and thus a color may be realized by excellent coloring power (refer to Experimental Example 1).

Further, the preparation method according to the present invention may control the thickness of the film formed on the surface of the matrix according to immersion conditions. Here, since the amount of heat conduction of the matrix varies depending on the thickness of the matrix, when the thicknesses of the matrices are different, the thickness of the films formed on matrices may be different even though the matrices were immersed under the same conditions. Accordingly, it is preferable to control the thickness of the film by adjusting immersion conditions according to the thickness of the matrix containing magnesium.

As an example, when the thickness of the matrix containing magnesium is in the range of 0.4 to 0.7 T, the concentration of the hydroxide solution may range from 1 to 80 wt %, and more specifically from 1 to 70 wt %; 5 to 50 wt %; 10 to 20 wt %; 1 to 40 wt %; 30 to 60 wt %; 15 to 45 wt %; 5 to 20 wt %; or 1 to 15 wt %. Moreover, the temperature of the hydroxide solution may range from 90 to 200° C., more specifically from 100 to 150° C., and even more specifically from 95 to 110° C. Further, the immersion time may be in the range of 1 to 500 minutes, and specifically in the range of 10 to 90 minutes. In the present invention, various colors may be economically realized on the surface of the substrate and a decrease in the intrinsic glossiness of the substrate due to an excessively increased thickness of the film may be prevented within the above-described range.

In an embodiment, it can be seen that the average thickness of the film formed on the surface of the substrate increases as the immersion time of the matrix passes, and it was confirmed that a color developed on the surface is changed accordingly. This indicates that the color realized on the surface is changed according to the thickness of the film. Therefore, it can be seen that the color realized on the surface of the substrate may be adjusted by controlling the concentration and temperature of the hydroxide solution for immersing the matrix and the immersion time (refer to Experimental Example 2).

Moreover, a step of immersing in the hydroxide solution may include: a first immersion step of immersing in a hydroxide solution with a concentration of N₁; and an n^{th} immersion step of immersing in a hydroxide solution with a concentration of Nₙ, and the first immersion step and the n^{th} immersion step may be carried out using a method in which the concentration of the hydroxide solution satisfies the following Expressions 3 and 4 independently of each other, and n is an integer of 2 or more and 6 or less:

8≦N₁≦25 [Expression 3]

|Nₙ₋₁−Nₙ|>3 [Expression 4]

where N₁ and Nₙ represent a concentration of a hydroxide solution in each step, and have units of wt %.

As described above, the step of immersing in the hydroxide solution is a step of realizing a color by forming a film on the surface of the substrate including magnesium, and the developed color may be controlled by adjusting the thickness of the formed film. Here, since the thickness of the film may be controlled according to the concentration of the hydroxide solution, when the concentration of the hydroxide solution for immersing the matrix is divided into N₁ to Nₙ, and specifically, N₁ to N₆; N₁ to N₅; N₁ to N₄; N₁ to N₃; or N₁ to N₂; and the matrix is sequentially immersed therein, minute differences in the color realized on the surface may be controlled.

Further, the method of color-treating the substrate according to the present invention substrate may further include one or more steps of: pretreating a surface before immersing in the hydroxide solution; patterning a surface of a matrix using a masking film before immersing in the hydroxide solution; and rinsing after immersing in the hydroxide solution.

Here, the step of pretreating the surface is a step of eliminating contaminants remaining on the surface by treating the surface using an alkaline cleaning solution or grinding the surface before forming the film on the matrix. Here, the alkaline cleaning solution is not particularly limited as long as the solution is generally used to clean a surface of metals, metal oxides or metal hydroxides in the related field. Further, the grinding may be performed by buffing, polishing, blasting, electrolytic polishing or the like, but is not limited thereto.

In the present step, not only pollutants or scales which are present on the surface of the matrix containing magnesium may be removed, but also the speed of forming the film may be controlled by surface energy of the surface and/or surface conditions, specifically, microstructural changes of the surface. That is, the thickness of the film formed on the polished matrix may be different from that of the film formed on the unpolished matrix even though the film is formed on the polished matrix under the same conditions as the film of the unpolished matrix, and each color developed on the surface may be different accordingly.

Further, the step of patterning is a step of patterning the surface of the matrix using a masking film before immersing the matrix in the hydroxide solution, and inducing the formation of a film with a patterned structure when immersing the matrix in the hydroxide solution.

Referring back to FIG. 2, no film is formed at a ‘patterned region 103’ which is patterned using a masking film according to the step of patterning when immersing the matrix in the hydroxide solution, while a film is formed at a ‘non-patterned region 104’ which is not patterned using a masking film, and thereby an average thickness deviation of the film between them is generated. Accordingly, a pattern may be realized due to a difference in colors developed on the surface.

Moreover, when a step of immersing the matrix in the hydroxide solution is further carried out before the step of patterning, as shown in FIG. 3, a relatively thin film as compared to a film formed at a ‘non-patterned region 204’ is also formed at a ‘patterned region 203’ and thereby a color may be developed, and the color developed at the ‘patterned region 203’ may be different from the color of the ‘non-patterned region 204’.

Here, the masking film is not particularly limited as long as the masking film may perform patterning on the surface of the matrix, and specifically, a thermal protection film which is releasable and has a resistance to heat applied when the step of immersing the matrix in the hydroxide solution is conducted or the like may be used.

Moreover, the step of rinsing is a step of eliminating any hydroxide solution remaining on the surface by rinsing the surface of the matrix after forming the film on the matrix, specifically after the step of immersing the matrix in the hydroxide solution. In this step, additional formation of the film due to any remaining hydroxide solution may be prevented by removing the hydroxide solution remaining on the surface of the matrix.

### [Mode for the Invention]

Hereinafter, the present invention will be described in further detail with reference to examples and experimental examples.

However, the following examples and experimental examples are for illustrative purposes only and not intended to limit the scope of the present invention.

### EXAMPLE 1

A magnesium-containing sample with a size of 1 cm×1 cm×0.4 T was degreased by immersing in an alkaline cleaning solution, and the degreased sample was immersed in a 10 wt % NaOH solution at 100° C. for 40 minutes. Thereafter, the sample was rinsed using distilled water and dried in a drying oven to prepare a color-treated sample.

### EXAMPLE 2

A sample color-treated to have a yellow color was prepared in the same manner as in Example 1 except that the magnesium-containing sample was immersed in a 10 wt % NaOH solution at 100° C. for 30 minutes instead of 40 minutes.

### EXAMPLE 3

A sample color-treated to have a purple color was prepared in the same manner as in Example 1 except that the magnesium-containing sample was immersed in a 10 wt % NaOH solution at 100° C. for 55 minutes instead of 40 minutes.

### EXAMPLE 4

A sample color-treated to have a green color was prepared in the same manner as in Example 1 except that the magnesium-containing sample was immersed in a 10 wt % NaOH solution at 100° C. for 80 minutes instead of 40 minutes.

### EXAMPLE 5

A magnesium-containing sample with a size of 4 cm×7 cm×0.4 T was degreased by immersing in an alkaline cleaning solution, and a masking film was attached to the degreased sample. Thereafter, the sample was immersed in a 10 wt % NaOH solution at 100° C. for 20 minutes, and then rinsed using distilled water and dried in a drying oven to prepare a patterned and color-treated sample. It can be determined that a pattern was formed on the surface of the sample when the sample was observed with the naked eye.

### EXAMPLE 6

A magnesium-containing sample with a size of 1 cm×1 cm×0.4 T was degreased by immersing in an alkaline cleaning solution, and the degreased sample was immersed in a 10 wt % NaOH solution at 100° C. for 50 minutes. Thereafter, the sample was rinsed using distilled water and dried, the dried sample was coated with a matte clear coating material in a liquid phase, and dried in an oven at 120 to 150° C. to prepare a matte clear coated sample. Here, a thickness of a matte clear coating layer was 5 μm or less.

### EXAMPLE 7

A color-treated and matte clear coated sample was prepared in the same manner as in Example 6 except that the magnesium-containing sample was immersed in a 10 wt % NaOH solution at 100° C. for 85 minutes instead of 50 minutes.

### EXAMPLE 8

A color-treated and glossy/matte clear coated sample was prepared in the same manner as in Example 6 except that a glossy/matte clear coating agent was used instead of the matte clear coating agent.

### COMPARATIVE EXAMPLES 1 TO 3

Color-treated samples were prepared in the same manner as in Example 1 except that the magnesium-containing sample was immersed in distilled water at 100° C. for the time shown in the following Table 1 instead of being immersed in a 10 wt % NaOH solution at 100° C. for 40 minutes.

TABLE 1

| | Immersion time |
|---|---|
| Comparative Example 1 | 40 minutes |
| Comparative Example 2 | 1 hour |
| Comparative Example 3 | 2 hours |

### EXPERIMENTAL EXAMPLE 1

### Evaluation of Coloring Efficiency of Substrate According to Type of Hydroxide Solution

In order to evaluate a coloring speed, coloring power and color uniformity of a substrate including magnesium according to a type of a solution used as a hydroxide solution, the following experiment was performed.

The coloring power of each color-treated sample prepared according to Example 1 and Comparative Examples 1 to 3 was evaluated with the naked eye. Further, any three points A to C which are present on each surface of the samples of Examples 2 to 4 and Comparative Example 3 were selected, and color coordinates in a CIE color space of the selected points were measured to calculate an average color coordinate deviation. Here, a color coordinate deviation (ΔE*) was derived using the following Expression 5, and the result is shown in the following Table 2.

ΔE*=\sqrt{(ΔL*)²+(Δa*)²+(Δb*)²} [Expression 5]

TABLE 2

| | 3 points | L* | a* | b* | ΔL* | Δa* | Δb* | ΔE* |
|---|---|---|---|---|---|---|---|---|
| Example 2 | A | 66.92 | 6.04 | 28.96 | — | — | — | — |
| | B | 66.98 | 5.81 | 58.97 | −0.06 | 0.23 | −0.01 | 0.237908 |
| | C | 66.92 | 5.73 | 59.17 | 0 | 0.31 | −0.21 | 0.374433 |
| Example 3 | A | 47.66 | 7.67 | −1.88 | — | — | — | — |
| | B | 47.61 | 8.02 | −1.42 | 0.05 | −0.35 | −0.47 | 0.58547227 |
| | C | 47.59 | 8.11 | −1.43 | 0.07 | −0.44 | −0.45 | 0.6296476 |
| Example 4 | A | 57.82 | −5.44 | 25.18 | — | — | — | — |
| | B | 57.84 | −5.35 | 25.56 | −0.02 | −0.09 | −0.38 | 0.391024 |
| | C | 57.58 | −5.17 | 25.15 | 0.24 | −0.27 | 0.03 | 0.271662 |
| Comparative | A | 44.58 | 7.46 | 20.13 | — | — | — | — |
| Example 3 | B | 42.33 | 8.47 | 17.02 | 2.25 | −1.01 | 3.11 | 3.919018 |
| | C | 41.70 | 8.25 | 16.9 | 2.88 | −0.79 | 3.23 | 4.399023 |

First, the coloring power of the color-treated samples prepared according to Example 1 and Comparative Examples 1 to 3 was observed with the naked eye, and the results show that the sample prepared using a NaOH solution as a hydroxide solution has a higher coloring speed than that of the sample prepared using distilled water as a hydroxide solution. More specifically, in the sample of Example 1 which is treated with a NaOH solution, it was determined that a silver color which is an intrinsic color of the sample was maintained 10 minutes after immersion, but the color was changed to a yellow color after 30 minutes had elapsed. However, in the case of the sample of Comparative Example 1, in which the immersion time was 40 minutes, among the samples of Comparative Examples 1 to 3 which are treated with distilled water, it was determined that a color change amount of the surface was slight and a color difference was not so large as compared to the non-color-treated substrate. Furthermore, it was determined that the sample of Comparative Example 2, in which the immersion time was 1 hour, was gradually colored to have a yellow color, and the sample of Comparative Example 3, in which the immersion time was 2 hours, was colored to have a yellow color, but the coloring power of the developed color was significantly lower than that of the sample of Example 1.

Next, referring to Table 2, it can be seen that the sample color-treated using a NaOH solution has a uniformly developed color. More specifically, in the case of the sample of Example 2 which is color-treated using a NaOH solution, color coordinate deviations of any three points which are present on the sample were determined as follows: ΔL*<0.06, 0.23≦Δa*<0.31, 0.01≦Δb*<0.21 and 0.237≦ΔE*<0.375. Further, color coordinate deviations of the samples of Examples 3 and 4 were also determined as 0.02≦ΔL*<0.24, 0.09≦Δa*<0.44, 0.03≦Δb*<0.47 and 0.271≦ΔE*<0.630, and it was confirmed that the deviations were not large. However, color coordinate deviations of the sample of Comparative Example 3 were determined as 2.25≦ΔL*<2.88, 0.79≦Δa*<1 .01, 3.11≦Δb*<3.23 and 3.919≦ΔE*<4.40, showing large color coordinate deviations.

From these results, it can be seen that the color treatment of the substrate including magnesium, in which the matrix is immersed in a hydroxide solution including NaOH, KOH, Mg(OH)₂, Ca(OH)₂, Ba(OH)₂ or the like, has high efficiency and the color developed therefrom is also uniform.

### EXPERIMENTAL EXAMPLE 2

### Evaluation of Coloring of Substrate According to Hydroxide Solution Immersion Time

In order to evaluate the degree of coloring of the substrate including magnesium according to immersion time, the following experiment was performed.

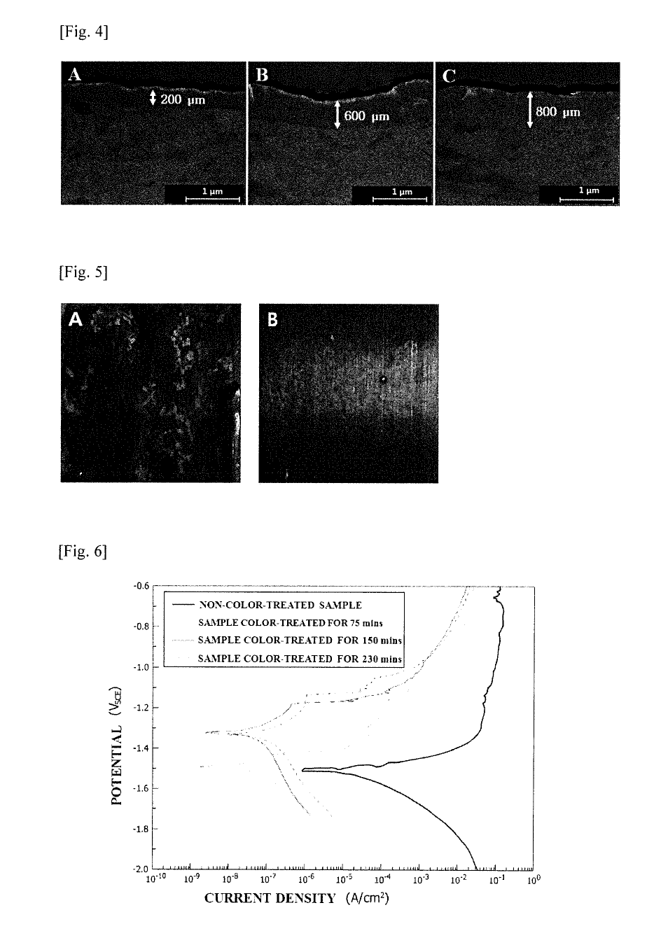

A magnesium-containing sample with a size of 1 cm×1 cm×0.4 T was degreased by immersing in an alkaline cleaning solution, and the degreased sample was immersed in a 10 wt % NaOH solution at 100° C. for 240 minutes. Here, a developed color was observed with the naked eye at intervals of 5 to 10 minutes immediately after the sample was immersed in the NaOH solution. Further, X-ray diffraction analysis and transmission electron microscope (TEM) imaging of the film was performed on the sample after 10 minutes, 170 minutes and 240 minutes of immersion in order to determine the component and thickness of the film formed on the surface of the sample. The result is shown in FIG. 4.

The color-treated substrate according to the present invention was determined to have a developed color varying according to the time of immersion in the hydroxide solution. More specifically, when the non-color-treated sample having a silver color was immersed in the hydroxide solution, it was determined that yellow, orange, red, purple, blue and green colors were sequentially developed after 30 minutes of immersion, and this color change becomes repeated at a predetermined interval over time.

Further, as a result of performing X-ray diffraction analysis on the films of the samples after 10 minutes, 170 minutes and 240 minutes of immersion in a 10 wt % NaOH solution, all the films of three samples were determined to have 20 diffraction peak values of 18.5±1.0°, 38.0±1.0°, 50.5±1.0°, 58.5±1.0°, 62.0±1.0° and 68.5±1.0°, and were confirmed to include magnesium hydroxide (Mg(OH)₂) having a brucite crystalline structure.

Moreover, as can be seen from FIG. 4, the average thickness of the film is increased to about 200 nm, 600 nm and 900 nm as each immersion time has passed.

From these results, it can be seen that the color-treated substrate according to the present invention realizes coloring by including the film containing magnesium hydroxide (Mg(OH)₂). Further, the thickness of the film formed on the surface may be controlled according to the immersion time of the substrate including magnesium, and the color developed therefrom may be controlled.

### EXPERIMENTAL EXAMPLE 3

### Evaluation of Corrosion Resistance of Color-Treated Substrate 1

In order to evaluate corrosion resistance of the color-treated substrate according to the present invention, the following experiment was performed.

The non-color-treated sample and the sample color-treated according to Example 4, which include magnesium and have a size of 1 cm×1 cm×0.4 T, each were uniformly sprayed with 5 wt % salt water at 35° C. using a salt spray tester (SST), and then the surface of the sample was observed with the naked eye after 942 hours. The result is shown in FIG. 5.

As can be seen from FIG. 5, the color-treated substrate according to the present invention has significantly improved corrosion resistance. More specifically, the non-color-treated sample is corroded due to salt water, and thus the surface of the samples was determined to be non-uniform and deformed when observed with the naked eye. In contrast, it was determined that the color-treated sample having the film formed thereon of Example 4 was slightly decolorized, and the surface of the sample was not deformed and had maintained its uniformity.

From these results, it can be seen that the substrate color-treated according to the present invention exhibits enhanced corrosion resistance by forming the film on the surface thereof.

### EXPERIMENTAL EXAMPLE 4

### Evaluation of Corrosion Resistance of Color-Treated Substrate 2

In order to evaluate corrosion resistance of the color-treated substrate according to the present invention, the following experiment was performed.

A non-color-treated sample which includes magnesium and has a size of 1 cm×1 cm×0.4 T, and samples prepared by respectively immersing samples which are the same as the above-described non-color-treated sample in a 10 wt % NaOH solution at 100° C. for 75 minutes, 150 minutes and 230 minutes were prepared. Then, the prepared samples were immersed in 0.5 wt % salt water for 72 hours, and then the non-color-treated sample and the color-treated sample were tested by a potentiodynamic polarization test. The measured potentiodynamic polarization curves are shown in FIG. 6. Tafel analysis was performed on the potentiodynamic polarization curves to obtain corrosion current density (I_{corr}), corrosion potential (E_{corr}) and critical pitting potential (Eₚᵢₜ) derived from a Tafel region (±200 mV) of the polarization curve of each sample. Further, the corrosion rate (Corr. Rate) was calculated from the values derived using the following Expression 6. The result is shown in the following Table 3.

$$Corrosion rate ( mm \text{/} year ) = \frac{0.00327 \times {I}_{corr} ( µA \text{/} {cm}^{2} ) \times E . W .}{Density ( g \text{/} {cm}^{3} )} \qquad [ Expression 6 ]$$

where E.W represents magnesium atomic weight/number of exchanged electrons=24.305/2; and density is 1.738 g/cm³.

TABLE 3

| | Non-color- | | | |
|---|---|---|---|---|
| | treated | Color-treated samples | | |
| | sample | 75 minutes | 150 minutes | 230 minutes |
| I_{corr} (μA/cm²) | 19.298 | 0.055 | 0.025 | 0.019 |
| E_{corr} (V_{SCE}) | −1.492 | −1.328 | 1.318 | −1.481 |
| Eₚᵢₜ (V_{SCE}) | — | −1.135 | −1.180 | −1.437 |
| E_{corr} − Eₚᵢₜ (V) | — | 0.193 | 0.138 | 0.044 |
| Corrosion rate | 0.4322 | 0.0013 | 0.0006 | 0.0004 |
| (mm/yr) | | | | |

As shown in Table 3, it can be seen that the color-treated substrate according to the present invention has excellent corrosion resistance.

More specifically, as a result of performing a potentiodynamic polarization test on the samples which were respectively immersed in the hydroxide solution for 75 minutes, 150 minutes and 230 minutes and the non-color-treated sample, it was determined that the color-treated samples have the corrosion rate (Corr. rate) of about 0.0004 to 0.0013 mm/yr, and the corrosion rate gradually decreases as the color treatment time increases. On the other hand, the non-color-treated sample was determined to have the corrosion rate of about 0.4322 mm/yr, which is about 330 times higher than those of the color-treated samples.

Form these results, it can be seen that the film formed on the surface of the color-treated substrate not only serves to realize a color on the surface, but also serves to prevent corrosion of the matrix containing magnesium.

### EXPERIMENTAL EXAMPLE 5

### Evaluation of Physical Properties of Color-Treated Substrate Having Top Coat Formed Thereon

In order to evaluate corrosion resistance and adhesiveness of the color-treated substrate having a top coat formed thereon, the following experiment was performed.

The experiment was performed on the color-treated samples of Examples 6 and 8 having a top coat formed thereon under the same conditions as that in Experimental Example 3, and the surface corrosion resistance; and the adhesiveness between the color-treated substrate and the top coat formed on the surface of the sample were evaluated after 72 hours of spraying salt water. Here, the adhesiveness was evaluated using a cross-cut tape test method. More specifically, the adhesiveness was evaluated using a method, in which a coated top coat was cut to have 6 vertical cuts and 6 horizontal cuts intersecting one another and formed at 1 mm intervals using a knife, the tape was firmly attached to the intersection points of the vertical cuts and horizontal cuts, and the area of the top coat which is peeled when the tape was quickly detached with respect to the total area of the sample was measured.

As a result, it can be seen that the color-treated substrate having the top coat formed thereon according to the present invention has excellent corrosion resistance, and outstanding adhesiveness between the color-treated substrate and the top coat. More specifically, it was determined that no deformation of the surface due to corrosion occurred in the case of the samples of Examples 6 and 8 having a matte or glossy/matte top coat thereon. Further, as a result of evaluating the adhesiveness of the sample on which a corrosion resistance test was performed, it was determined that the area of the top coat which is delaminated due to the tape is 5% or less based on the total area of the top coat.

From these results, it can be seen that the color-treated substrate having a top coat formed thereon according to the present invention has excellent corrosion resistance as well as outstanding adhesiveness between the color-treated substrate and the top coat.

Accordingly, the color-treated substrate according to the present invention is advantageous in that the homogeneity and corrosion resistance of a surface may be improved and a uniform color may be realized in a short period of time by forming the film on the surface by immersing a matrix containing magnesium in a hydroxide solution including NaOH, KOH, Mg(OH)₂, Ca(OH)₂, Ba(OH)₂, etc. Consequently, the color-treated substrate may be usefully used in the fields of building exterior materials, automobile interiors, and particularly electrical and electronic component materials, such as mobile phone case components, in which a magnesium material is used.

### INDUSTRIAL APPLICABILITY

The color-treated substrate according to the present invention can improve the homogeneity and corrosion resistance of a surface of a substrate, and realize a uniform color in a short period of time by forming a film containing a compound represented by Chemical Formula 1 on a surface of a matrix containing magnesium. Accordingly, the color-treated substrate can be usefully used in the fields of building exterior materials, automobile interiors, and particularly electrical and electronic component materials, such as mobile phone case components, in which a magnesium material is used.

1. A color-treated substrate, comprising:
a matrix containing magnesium; and
a film formed on the matrix and containing a compound represented by the following Chemical Formula 1,
wherein, at any three points included in an arbitrary region with a width of 1 cm and a length of 1 cm which is present on the film, an average color coordinate deviation (ΔL*, Δa*, Δb*) of each point satisfies one or more conditions of ΔL*<0.6, Δa*<0.6 and Δb*<0.5:
M(OH)ₘ [Chemical Formula 1]
where M includes one or more selected from the group consisting of Na, K, Mg, Ca and Ba, and m is 1 or 2.

2. The color-treated substrate according to claim 1, wherein an average thickness of the film is in a range of 50 nm to 2 μm.

3. The color-treated substrate according to claim 1, wherein the film has a patterned structure which realizes an intended pattern on the matrix containing magnesium.

4. The color-treated substrate according to claim 3, wherein the pattern is realized by an average thickness deviation of the film satisfying a condition of the following Expression 1:
5 nm≦|T₁−T₂|<2.0 μm [Expression 1]
where T₁ represents a film average thickness of a patterned region, and T₂ represents a film average thickness of a non-patterned region.

5. The color-treated substrate according to claim 1, wherein a condition of the following Expression 2 is satisfied when evaluating corrosion resistance:
Corrosion rate (Corr. Rate)≦0.01
where corrosion rate (Corr. Rate) represents a degree of corrosion of a color-treated substrate measured in 0.5 wt % salt water by a potentiodynamic polarization test, and has units of mm/year.

6. The color-treated substrate according to claim 1, wherein the film includes magnesium hydroxide (Mg(OH)₂).

7. The color-treated substrate according to claim 1, wherein the matrix further includes stainless steel or titanium (Ti).

8. The color-treated substrate according to claim 1, further comprising a top coat formed on the film.

9. A method of color-treating a substrate, comprising a step of immersing a matrix containing magnesium in a hydroxide solution.

10. The method according to claim 9, wherein the hydroxide solution includes one or more selected from the group consisting of NaOH, KOH, Mg(OH)₂, Ca(OH)₂ and Ba(OH)₂.

11. The method according to claim 9, wherein a concentration of the hydroxide solution is in a range of 1 to 80 wt %.

12. The method according to claim 9, wherein the step of immersing in the hydroxide solution is performed for 1 to 500 minutes with a temperature of the hydroxide solution in a range of 90 to 200° C.

13. The method according to claim 9, further comprising one or more steps of:
pretreating a surface before the step of immersing in the hydroxide solution;
patterning a surface of a matrix using a masking film before the step of immersing in the hydroxide solution; and
rinsing after the step of immersing in the hydroxide solution.

14. The method according to claim 13, further comprising a step of immersing a matrix containing magnesium in a hydroxide solution before the step of patterning using the masking film.

15. The method according to claim 13, wherein the masking film is a thermal protection film which is releasable.

16. The method according to claim 9, wherein the step of immersing in the hydroxide solution includes:
a first immersion step of immersing in a hydroxide solution with a concentration of N₁; and
an n^{th} immersion step of immersing in a hydroxide solution with a concentration of Nₙ, the concentration of the hydroxide solution in the first immersion step and the n^{th} immersion step satisfies the following Expressions 3 and 4 independently of each other, and n is an integer of 2 or more and 6 or less:
8≦N₁≦25 [Expression 3]

|Nₙ₋₁−Nₙ|>3 [Expression 4]
where N₁ and Nₙ represent a concentration of a hydroxide solution in each step, and have units of wt %.
